(19) United States
(12) Patent Application Publication
(10) Pub. No.: US 2025/0248401 A1
(43) Pub. Date: Aug. 7, 2025

(54) Regulator for Highland Barley and Preparation Method and Application Thereof

(71) Applicant: Institute of Crop Science, Chinese Academy of Agricultural Sciences, Beijing (CN)

(72) Inventors: Zhiqiang DONG, Beijing (CN); Yawei TANG, Beijing (CN); Peng YAN, Beijing (CN); Lin LU, Beijing (CN); Guocheng JIAO, Beijing (CN); Luobu ZHAXI, Beijing (CN)

(73) Assignee: Institute of Crop Science, Chinese Academy of Agricultural Sciences, Beijing (CN)

(21) Appl. No.: 18/433,424

(22) Filed: Feb. 6, 2024

(30) Foreign Application Priority Data
Dec. 6, 2022 (CN) 202211557026.7

(51) Int. Cl. A01P 21/00; A01N 43/08; A01N 57/20

(52) U.S. Cl. CPC A01N 43/08; A01N 57/20; A01P 21/00

(57) ABSTRACT

The present invention belongs to the technical field of pesticides and provides a regulator for highland barley and preparation method and application thereof. The regulator uses water as a solvent and includes components with the following concentrations: 60-84 g/L of lentinan, 150-210 g/L of ethephon, 100-140 g/L of polyaspartic acid salt, and 15-25 mL/L of active agent. The regulator of the present invention can induce highland barley to establish a huge root system, increase the toughness of highland barley stems, dwarf the length of highland barley internodes, reduce plant height, and improve the ability of highland barley to resist lodging; at the same time, it can improve the photosynthetic performance of highland barley leaves and the development of spikes, and promotes high and stable yield of highland barley.

### CROSS REFERENCE TO THE RELATED APPLICATIONS

This application is based upon and claims priority to Chinese Patent Application No. 202211557026.7, filed on Dec. 6, 2022, the entire contents of which are incorporated herein by reference.

### TECHNICAL FIELD

The present invention relates to the technical field of pesticides, and in particular to a regulator for highland barley and preparation method and application thereof.

### BACKGROUND

Highland barley belongs to genus Hordeum of Poaceae family. It is called naked barley, hulless barley, rice wheat, etc., because the inner and outer husks separate from the kernels at maturity. Highland barley is rich in various vitamins, minerals, trace elements, etc., and can be used to make tsampa and highland barley wine. Research has found that highland barley contains unique β-glucan, flavonoids and other components, and has characteristics such as high β-glucan, high dietary fiber, and low fat. Its health care functions have gradually been discovered and recognized. In field production, compared with other wheat crops, highland barley is extremely prone to lodging due to its shallow root system, long basal internodes, thin stem walls, and soft texture. In particular, when exposed to adverse conditions such as strong winds, heavy rain, hail, overcast skies with limited sunlight, low-temperature stress, and pest infestation, as well as improper cultivation practices related to fertilization, irrigation, and planting density, highland barley is susceptible to lodging. The lodging of highland barley mainly occurs in the later stages of grain filling. After lodging, the plants become stacked and disrupt the spatial distribution structure of the leaves. This disturbance compromises the above-ground population structure, leading to poor ventilation and light transmission. The lower functional leaves lose their efficiency, resulting in yellowing and rotting. The decreased photosynthetic activity, coupled with damage to the internodes at the base, hinders stem transport function, obstructing assimilate movement, and severely inhibits plant growth and development. This, in turn, causes grain wrinkling, shriveled seeds, and other undesirable phenomena. After lodging, the number of grains per spike, bulk density, and overall setting percentage of the highland barley significant decrease, leading to a reduction in both yield and quality. This poses certain challenges for the later-stage harvest.

Selecting lodging-resistant varieties, implementing proper planting density, making a rational combined application of nitrogen, phosphorus, and potassium, employing rational irrigation practices, and employing scientific methods for pest and disease control are cultivation techniques that can enhance the lodging resistance of highland barley to some extent and reduce production losses. However, the application conditions and effectiveness are limited. The use of chemical regulation technology, such as foliar spraying of plant growth regulators like paclobutrazol and chlormequat chloride during the tillering to jointing stage of highland barley, can prevent excessive elongation of internodes at the base and reduce lodging in some ways. Nevertheless, these measures may lead to a reduction in highland barley yield. Therefore, the research and development of specialized lodging-resistant and yield-increasing regulators for highland barley reduces lodging rates and improves both the yield and quality of highland barley on the basis of ensuring the normal growth and development of highland barley, which holds significant importance for the development of plateau characteristic agricultural production.

### SUMMARY

The purpose of the present invention is to provide a regulator for highland barley and preparation method and application thereof. The regulator can improve the ability of highland barley to resist lodging, improve the photosynthetic performance of its leaves, promote spike development, and boost high and stable yield.

To achieve the objectives, the present invention provides the following technical solutions:

The present invention provides a regulator for highland barley, using water as a solvent and including components at the following concentrations: 60-84 g/L of lentinan, 150-210 g/L of ethephon, 100-140 g/L of polyaspartic acid salt, and 15-25 mL/L of active agent.

Preferably, the polyaspartic acid salt includes potassium polyaspartate.

Preferably, the active agent includes Tween 20 and/or Tween 60.

The present invention also provides a preparation method for the regulator for highland barley, including the following steps:
sequentially adding polyaspartic acid salt and lentinan to water, adding ethephon after mixing, and then adding active agent after remixing, to obtain the regulator.

The present invention further provides the application of the regulator for highland barley in improving yield and lodging resistance.

Preferably, the method of using the regulator is applying foliar spray after diluting it 500-700 times.

Preferably, the application time for the regulator is during the jointing stage of highland barley and/or 3-7 days before heading. Compared to the prior art, the beneficial effects of the present invention include:

In the regulator of the present invention, polyaspartic acid can activate phosphodiesterase, regulate calcium metabolism, improve cell physiological functions, promote the development of spike organs, increase grain weight per spike, and improve grain quality. Lentinan contains protein polysaccharides and trace elements, which can enhance the metabolic activity of highland barley cells, promote spike organ development, increase the fertilization rate of female spikelets, reduce the rate of abortive grain; at the same time, lentinan has the effect of preventing the spread of viruses, which can effectively reduce the disease of highland barley. Ethephon can shorten the internodes at the base of highland barley, reduce plant height, promote radial growth of the stem, enhance stem toughness, promote the development of adventitious roots, and increase the lodging resistance of highland barley.

The regulator of the present invention is a product with a dual function of enhancing lodging resistance and increasing yield in highland barley. It is characterized by being non-toxic, having no side effects, low cost, and easy to use. Due to the novel and unique formulation of this product, a single application can achieve multiple effects. Compared to existing plant growth regulators that adjust morphological and yield indicators in highland barley, it has the advantages of low investment, wide-ranging effects, and the comprehensive improvement of lodging resistance and yield in highland barley. Therefore, the present invention plays a positive role in promoting highland barley production in China. According to observations from multiple demonstration trials conducted by the inventors at the Lhasa Comprehensive Experimental Station of the Tibet Academy of Agricultural and Animal Husbandry Sciences and the Bailang Experimental Base in Lhoka City, Tibet Autonomous Region (Zalin Village, Luojiang Town, Bailang County), after applying this product, no lodging occurred in all experimental highland barley fields in 2020 and 2021, while varying degrees of lodging were observed in control fields with lodging rates ranging from 37% to 62%. The yield was increased by more than 20% on average compared to the control fields.

After the application of the regulator provided by the present invention, the root system of highland barley becomes extensive, with numerous secondary roots exhibiting increased length. The root system displays enhanced vitality, contributing to improved anchoring in the soil and increased nutrient absorption capacity. This, in turn, leads to robust seedlings with heightened resistance to drought, low temperatures, and overall enhanced resilience in adverse conditions. Furthermore, the regulator reduces internode length of highland barley stems, resulting in thicker and sturdier stems, reduced plant height by 10 cm, improves plan shape, heightened lignification of stem tissues, and the development of a huge root system, contributing to enhanced lodging resistance. The structural and functional improvements extend to the canopy of highland barley, with leaves becoming broader, thicker, and more vibrant green, thereby extending their functional period. The canopy gains increased permeability, promoting enhanced photosynthesis, increased thousand-grain weight, and precocity. Yield-related effects include the stimulation of robust spike development, an increase in the number of effective spikes, higher grain weight per spike, overall improvement in highland barley quality, and a substantial yield increase of over 20%.

### DETAILED DESCRIPTION OF THE EMBODIMENTS

The present invention provides a regulator for highland barley, using water as a solvent and including components at the following concentrations: 60-84 g/L of lentinan, 150-210 g/L of ethephon, 100-140 g/L of polyaspartic acid salt, and 15-25 mL/L of active agent.

In the present invention, the lentinan was purchased from Beijing Sanpu Baicao Green Plant Preparations Co., Ltd. (Registration Certificate No.: PD20121979).

In the present invention, water is used as a solvent to prepare the regulator for highland barley including 60-84 g/L of lentinan, preferably 65-80 g/L, and further preferably 70-75 g/L.

In the present invention, water is used as a solvent to prepare the regulator for highland barley including 150-210 g/L of ethephon, preferably 160-200 g/L, and further preferably 170-190 g/L.

In the present invention, water is used as the solvent to prepare the regulator for highland barley including 100-140 g/L of polyaspartic acid salt, preferably 110-130 g/L, and further preferably 115-125 g/L.

In the present invention, water is used as a solvent to prepare the regulator for highland barley including 15-25 mL/L of active agent, preferably 17-23 mL/L, and further preferably 19-21 mL/L.

In the present invention, the polyaspartic acid salt includes potassium polyaspartate.

In the present invention, the active agent includes Tween 20 and/or Tween 60.

The present invention also provides a preparation method for the regulator for highland barley, including the following steps:
sequentially adding polyaspartic acid salt and lentinan to water, adding ethephon after mixing, and then adding active agent after remixing, to obtain the regulator.

The present invention further provides the application of the regulator for highland barley in improving yield and lodging resistance.

In the present invention, the use method of the regulator is to dilute the regulator 500-700 times and then apply foliar spray, preferably 550-650 times, and further preferably 580-630 times.

In the present invention, the use time of the regulator is during the highland barley jointing stage and/or 3-7 days before highland barley heading, preferably during the highland barley jointing stage and/or 4-6 days before highland barley heading, further preferably during the highland barley jointing stage and/or 5 days before highland barley heading.

The technical solutions provided by the present invention will be described in detail below with reference to the examples, but they should not be understood as limiting the protection scope of the present invention.

### Embodiment 1

The embodiment provides a regulator for highland barley, with the following components: 100 g of potassium polyaspartate, 60 g of lentinan, 150 g of ethephon, 20 mL of Tween 20 and water.

The preparation method is as follows:

Sequentially add 100 g of potassium polyaspartate and 60 g of lentinan to 500 mL of water. After complete dissolution, add 150 g of ethephon to the solution. After dissolution, add 20 mL of Tween 20 and dilute with water to 1000 mL.

### Embodiment 2

The embodiment provides a regulator for highland barley, with the following components: 140 g of potassium polyaspartate, 60 g of lentinan, 150 g of ethephon, 20 mL of Tween 60 and water.

The preparation method is as follows:

Sequentially add 140 g of potassium polyaspartate and 60 g of lentinan to 500 mL of water. After complete dissolution, add 150 g of ethephon to the above solution. After dissolution, add 20 mL of Tween 60 and dilute with water to 1000 mL.

### Embodiment 3

The embodiment provides a regulator for highland barley, with the following components: 100 g of potassium polyaspartate, 84 g of lentinan, 150 g of ethephon, 20 mL of Tween 20 and water.

The preparation method is as follows:

Sequentially add 100 g of potassium polyaspartate and 84 g of lentinan to 500 mL of water. After complete dissolution, add 150 g of ethephon to the above solution. After dissolution, add 20 mL of Tween 20 and dilute with water to 1000 mL.

### Embodiment 4

This embodiment provides a regulator for highland barley, with the following components: 140 g of potassium polyaspartate, 84 g of lentinan, 150 g of ethephon, 10 mL of Tween 20, 10 mL of Tween 60 and water.

The preparation method is as follows:

Sequentially add 140 g of potassium polyaspartate and 84 g of lentinan to 500 mL of water. After complete dissolution, add 150 g of ethephon to the solution. After dissolution, add 10 mL of Tween 20 and 10 mL of Tween 60 and dilute with water to 1000 mL.

### Embodiment 5

The embodiment provides a regulator for highland barley, with the following components: 100 g of potassium polyaspartate, 60 g of lentinan, 210 g of ethephon, 20 mL of Tween 60 and water.

The preparation method is as follows:

Sequentially add 100 g of potassium polyaspartate and 60 g of lentinan to 500 mL of water. After complete dissolution, add 210 g of ethephon to the above solution. After dissolution, add 20 mL of Tween 60 and dilute with water to 1000 mL.

### Embodiment 6

The embodiment provides a regulator for highland barley, with the following components: 140 g of potassium polyaspartate, 60 g of lentinan, 210 g of ethephon, 20 mL of Tween 60 and water.

The preparation method is as follows:

Sequentially add 140 g of potassium polyaspartate and 60 g of lentinan to 500 mL of water. After complete dissolution, add 210 g of ethephon to the above solution. After dissolution, add 20 mL of Tween 60 and dilute with water to 1000 mL.

### Embodiment 7

This embodiment provides a regulator for highland barley, with the following components: 100 g of potassium polyaspartate, 84 g of lentinan, 210 g of ethephon, 10 mL of Tween 20, 10 mL of Tween 60 and water.

The preparation method is as follows:

Sequentially add 100 g of potassium polyaspartate and 84 g of lentinan to 500 mL of water. After complete dissolution, add 210 g of ethephon to the solution. After dissolution, add 10 mL of Tween 20 and 10 mL of Tween 60 and dilute with water to 1000 mL.

### Embodiment 8

The embodiment provides a regulator for highland barley, with the following components: 140 g of potassium polyaspartate, 84 g of lentinan, 210 g of ethephon, 20 mL of Tween 20 and water.

The preparation method is as follows:

Sequentially add 140 g of potassium polyaspartate and 84 g of lentinan to 500 mL of water. After complete dissolution, add 210 g of ethephon to the above solution. After dissolution, add 20 mL of Tween 20 and dilute with water to 1000 mL.

### Experimental Example

The regulator prepared in Example 1 was subjected to field experiments, and a regulator with only one component added was selected as a control. The grouping information is shown in Table 1:

TABLE 1
Field experiment grouping

| | Potassium | Ethephon | Lentinan |
|---|---|---|---|
| | polyaspartate | concentration | concentration |
| Group | concentration (ppm) | (ppm) | (ppm) |
| Embodiment 1 | 200 | 300 | 120 |
| CK | — | — | — |
| P1 | 100 | — | — |
| P2 | 200 | — | — |
| E1 | — | 300 | — |
| E2 | — | 600 | — |
| L1 | — | — | 60 |
| L2 | — | — | 120 |

The preparation method for each group of regulators in Table 1 is as follows: sequentially add polyamino acid potassium, lentinan or ethephon, dissolve in the water according to the formula proportion, then add 20 mL of Tween 20 and dilute with water to 1000 mL. When used, dilute with water to a 500-fold solution.

Taking Zangqing 2000 as the test variety, foliar spraying was carried out at the jointing stage and 5 days before heading, with three repetitions. Harvesting was done at the maturity, and the yield measured. The results are shown in Table 2. As indicated in Table 2, the three components have a significant synergistic effect, reducing plant height by 3.7%, increasing spike length by 8.2%, increasing effective spike number by 13.1%, increasing grain number per spike by 9.8%, increasing thousand-grain weight by 5.6%, and increasing yield by 31.1%.

TABLE 2
Synergistic effect experiment of polyaspartic acid (PASP), ethephon (ETH) and lentinan (LT)

| Treatment | CK | P1 | P2 | E1 | E2 | L1 | L2 | Embodiment 1 |
|---|---|---|---|---|---|---|---|---|
| Plant height | 119.2 | 120.1 | 120.3 | 114.8 | 113.3 | 119.7 | 119.4 | 114.8 |
| (cm) | | | | | | | | |
| Increase | / | 0.8 | 0.9 | −3.7 | −4.9 | 0.4 | 0.2 | −3.7 |
| compared to | | | | | | | | |
| control (%) | | | | | | | | |
| Spike length | 6.1 | 6.8 | 7.1 | 6.5 | 6.2 | 6.6 | 7.0 | 6.6 |
| (cm) | | | | | | | | |
| Increase | / | 11.5 | 16.4 | 6.6 | 1.6 | 8.2 | 14.8 | 8.2 |
| compared to | | | | | | | | |
| control (%) | | | | | | | | |
| Effective spike | 19.1 | 20.1 | 20.6 | 20.8 | 20.4 | 20.4 | 20.7 | 21.6 |
| number | | | | | | | | |
| (10,000 | | | | | | | | |
| spikes/667 m²) | | | | | | | | |
| Increase | / | 5.2 | 7.9 | 8.9 | 6.8 | 6.8 | 8.4 | 13.1 |
| compared to | | | | | | | | |
| control (%) | | | | | | | | |
| Grain number | 39.8 | 42.3 | 42.7 | 42.1 | 42.2 | 41.8 | 41.5 | 43.7 |
| per spike | | | | | | | | |
| (grains/spike) | | | | | | | | |
| Increase | / | 6.3 | 7.3 | 5.8 | 6.0 | 5.0 | 4.3 | 9.8 |
| compared to | | | | | | | | |
| control (%) | | | | | | | | |
| Thousand-grain | 41.2 | 43.1 | 43.5 | 43.6 | 43.2 | 42.8 | 42.6 | 43.5 |
| weight (g) | | | | | | | | |
| Increase | / | 4.6 | 5.6 | 5.8 | 4.9 | 3.9 | 3.4 | 5.6 |
| compared to | | | | | | | | |
| control (%) | | | | | | | | |
| Yield (kg · hm⁻²) | 313.2d | 366.4c | 382.6b | 381.8b | 371.9bc | 365.0c | 366.0c | 410.6a |
| Increase | / | 17.0 | 22.2 | 21.9 | 18.7 | 16.5 | 16.8 | 31.1 |
| compared to | | | | | | | | |
| control (%) | | | | | | | | |

As can be seen from the examples, the present invention provides a regulator for highland barley and preparation method and application thereof. The regulator can improve the ability of highland barley to resist lodging, improve the photosynthetic performance of highland barley leaves and promote the development of spikes, thereby facilitating high and stable yields of highland barley.

The embodiments described herein are only preferred embodiments of the present invention. It should be noted that those skilled in the art could make various improvements and modifications without departing from the principles of the present invention. Such improvements and modifications should be considered within the protection scope of the present invention.

What is claimed is:

1. A regulator for highland barley using water as a solvent and comprising components at the following concentrations: 60-84 g/L of lentinan, 150-210 g/L of ethephon, 100-140 g/L of polyaspartic acid salt, and 15-25 mL/L of active agent;
wherein the active agent is Tween 20 and/or Tween 60.

2. The regulator for highland barley according to claim 1, wherein the polyaspartic acid salt comprises potassium polyaspartate.

3. A preparation method of the regulator for highland barley according to claim 1, comprising the following steps:
sequentially adding the polyaspartic acid salt and the lentinan to water, adding the ethephon after mixing, and then adding the active agent after remixing, to obtain the regulator.

4. An pplication method of the regulator for highland barley according to claim 1, comprising: using the regulator in improving yield of highland barley and enhancing a resistance to lodging of the highland barley.

5. The application method according to claim 4, wherein the method of using the regulator comprises diluting the regulator 500-700 times and then performing foliar spray.

6. The application method according to claim 4, wherein a period of use of the regulator is during a jointing stage of the highland barley and/or 3-7 days before a heading.

7. The preparation method according to claim 3, wherein in the regulator, the polyaspartic acid salt comprises potassium polyaspartate.

8. The application method according to claim 4, wherein in the regulator, the polyaspartic acid salt comprises potassium polyaspartate.
